(19) United States
(12) Patent Application Publication
(10) Pub. No.: US 2010/0058647 A1
(43) Pub. Date: Mar. 11, 2010

(54) STRUCTURE OF AN INHIBITING CONTAINER AND DEVICE, AS WELL AS METHOD OF ASSEMBLING SAID DEVICE TO A CONTAINMENT BODY

(76) Inventor: Luca Stragapede, Monticello Conte otto VI (IT)

Correspondence Address: K.F. ROSS P.C., 5683 RIVERDALE AVENUE, SUITE 203 BOX 900, BRONX, NY, 10471-0900, US

(21) Appl. No.: 12/514,628

(22) PCT Filed: Nov. 13, 2007
(86) PCT No.: PCT/IB07/03466

§ 371 Date: May 13, 2009

(30) Foreign Application Priority Data
Nov. 14, 2006 (IT) PD2006A000422

(51) Int. Cl. A01M 1/20

(52) U.S. Cl. 43/131; 43/132.1

(57) ABSTRACT

Structure (10) of an inhibiting container to inhibit the proliferation of insects in a liquid body, comprising a containment body (11) to contain said liquid body and inhibiting devices (17) in contact with said liquid body to inhibit said proliferation of insects, wherein said inhibiting devices are at least partially incorporated in said containment body so that said container structure simultaneously performs both the functions of containing said liquid and of being insecticidal to said insects. The invention also refers to an inhibiting device capable of being incorporated in a containment body and to a method of assembling said device to said containment body to realize said structure of an inhibiting container.

The object of this invention refers to a structure of an inhibiting container to inhibit the proliferation of insects in a liquid body, an inhibiting device capable of being incorporated in a containment body, and a method of assembling said device to said containment body to set up said container structure. Said container structure, said device and said method are especially, while not exclusively, employed in a domestic environment.

Numerous strategies and devices are used in branch of fighting insect proliferation. The latest strategies, which have been especially developed to combat mosquitoes, are aimed at hitting these insects particularly at their larval state. These strategies are preferably actuated in the liquid body wherein the vital cycle of said insects begins. Among these strategies, the one based on introducing appropriate quantities of bacteriostatic metals, in particular copper, in the liquid body that hosts the birth and growth of said insects holds particular promise. Numerous laboratory tests have in fact demonstrated that said metals induce such distortions of the cellular permeability in the larval cells of said insects as to determine dissolution of these cells and therefore death. The diffusion of the knowledge of this strategy beyond the strictly experimental realm has generated the first practical tests. Certain public institutions have in fact recently invited dwellers to introduce small bits of copper in the stagnant water containers as saucers for ornamental and fruit plants, drainage pits and channels, etc. The market also offers products especially developed to implement this strategy, which essentially consist in small bits of copper prepared and packaged in various shapes and ways, depending on destination and usage. In this context, the European patent application No. 05021288.5 has for instance made known a product for use against larval development in water. This product essentially comprises bacteriostatic elements to be placed in contact with water, so as to inhibit the proliferation of the insects. Said bacteriostatic elements in turn comprise appropriate quantities of bacteriostatic metals such as copper. The use of this product envisages in short immersing said product in appropriate volumes of water collected from the container to be treated. This realizes a structure of an inhibiting container capable of inhibiting the proliferation of said insects.

The main drawback found in the products according to the described prior art consists in the generally limited interest arisen among users. Said limited interest appears to be due to the numerous usage problems found by the users. The latter must in fact purchase a product functionally suitable for the type of container to be treated, study the instructions of usage of said product in order to properly implement its application and act in accordance with these instructions.

A second drawback found in the products according to the prior art described above consists in a risk of ingestion on the part of children and household pets. This risk is particularly heightened in applications where the bacteriostatic elements are of a small size and readily available, as occurs for instance when treating saucers.

A further drawback found in the products according to the prior art described above consists in the disposal problems faced by the users. The latter must in fact manually collect the exhausted bacteriostatic elements and deliver them to the authorized collection centres that will convey them to the companies specialized in metals recycling.

Not the last drawback found in the structure of an inhibiting container producible according to the prior art described above consists in that the outcome of the treatment may be affected by the presence of locally insufficient or excessive concentrations of bacteriostatic elements in the treating water, due to an improper application of the product.

The aim of the present invention consists in setting up a structure of an inhibiting container to inhibit the proliferation of insects in a liquid body, a device capable of being incorporated in a containment body and a method of assembling said device to said containment body to set up said structure of a container, so as to make them capable of resolving the drawbacks found in the prior art described above.

Within this aim, an object of the invention consists in setting up a structure of a container and a device capable of ensuring high practical standards of usage, so as to motivate users to adopt it.

Another object of the invention consists in setting up a structure of a container and a device capable of ensuring absolute safety standards, primarily with respect to children and household pets.

A further object of the invention consists in setting up a structure of a container and a device capable of facilitating disposal operations.

An additional object of the invention consists in setting up a structure of a container and a device capable of ensuring a positive result of the bacteriostatic treatment.

Another object consists in setting up a structure of a container to be aesthetically enhanced.

Not the last object of the invention consists in setting up a structure of a container and a device to be economical, easily produced, fully and easily recycled and a method for their assembly to be implemented promptly and easily.

This aim, as well as this and other objects that will be better apparent in the following, are achieved by the structure of an inhibiting container to inhibit the proliferation of insects in a liquid body, by an inhibiting device capable of being incorporated in a containment body and by a method of assembling said device with said containment body to realize said structure of a container according to the attached claims.

According to main features of the invention, the structure of the inhibiting container to inhibit the proliferation of insects in a liquid body advantageously comprises a containment body to contain said liquid body to inhibit said the proliferation of insects and inhibiting devices in contact with said liquid body to inhibit said proliferation of said insects, wherein the said inhibiting devices are at least partially incorporated in said containment body, so that said structure of a container simultaneously performs both functions of containing said liquid body and of being insecticidal to said insects.

This solution allows achieving the aim of setting up a structure of a container and a device with high practical standards of usage. In order to achieve such a bifunctional valence, none or only minimal assembling operations are demanded from the user.

Moreover, this solution allows achieving the object of setting up a structure of a container and a device endowed with absolute safety standards with respect to children and household pets. The partial incorporation of the inhibiting devices in the containment body in fact impedes even their accidental separation, and consequently averts any risk of ingestion in an absolute manner.

This solution also allows achieving the object of setting up a structure of a container and a device capable of facilitating disposal operations. It suffices in fact that the user hand over the entire structure of the container or the mere inhibiting devices to a collection center, and that the companies specializing in metals recycling mechanically remove the inhibiting devices from the containment body, or directly subject the inhibiting devices to treatment.

According to second features of the invention, said inhibiting devices are uniformly arranged on said containment body.

This solution therefore allows achieving the object of setting up a structure and a device capable of ensuring a positive result of the bacteriostatic treatment. In fact, the uniform arrangement of the inhibiting devices within said structure always guarantees a satisfactory result.

According to these and other features of the invention, said inhibiting devices produce geometric configurations on said containment body.

This solution thus allows achieving the object of setting up a structure of a container that is aesthetically enhanced. This feature assumes particular relevance for the branch of producing saucers for ornamental and/or fruit plants, as said aesthetic enhancement produces a further motivation to prefer saucers realized according to this invention rather than traditional ones.

According to this and yet other features of the invention, said structure of a container and device prove to be economical, easily produced, fully and easily recycled, and their method of assembly turns out to be implemented in a simple and immediate manner.

Further features and advantages of the invention will be better apparent from the description of the preferred embodiments of the structure of the inhibiting container, the inhibiting device, and the method of assembly that are illustrated, for indicative yet thereby non-limiting purposes, in the four attached drawings, wherein:

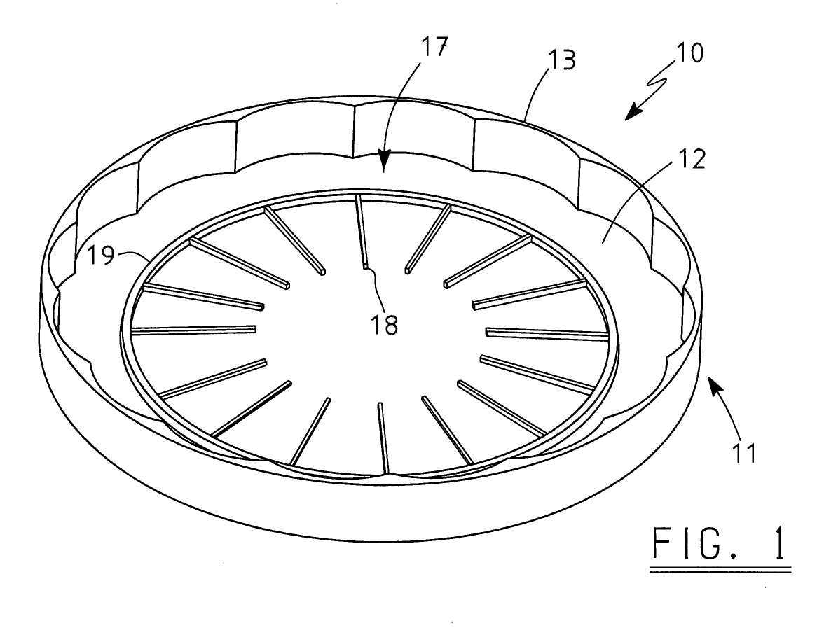

The FIG. 1 represents a prospective view of a first embodiment of the structure of container, according to the invention, set up in a circular manner;

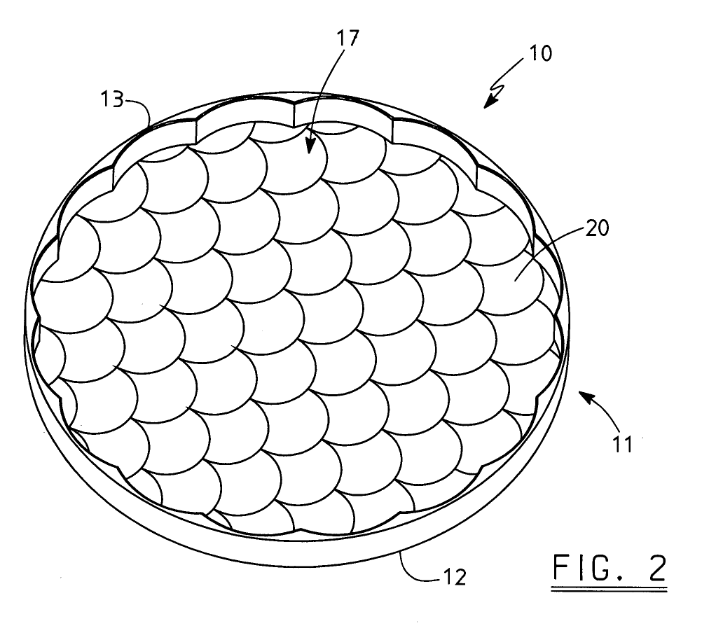

The FIG. 2 represents a prospective view of a second embodiment of the structure of the container according to the invention, again set up in a circular manner;

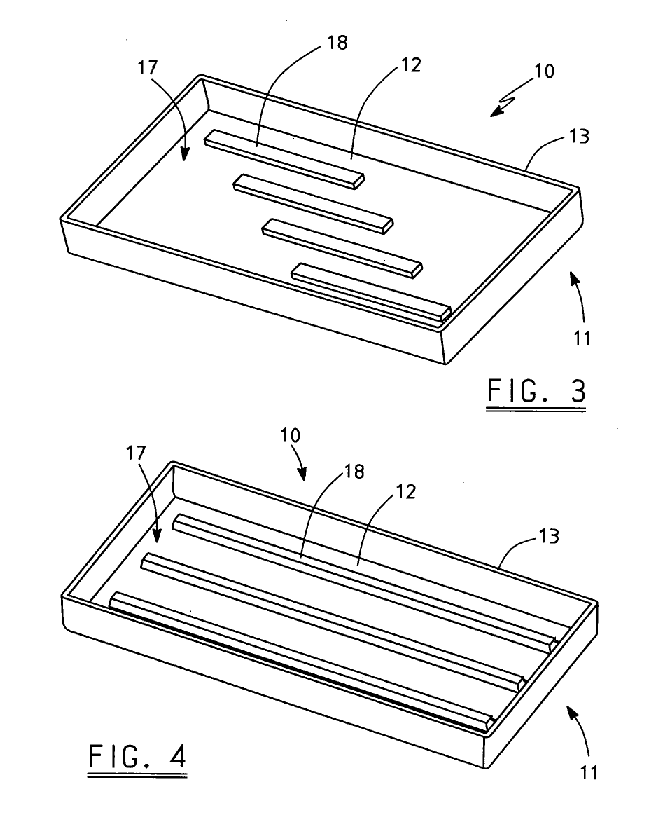

The FIG. 3 represents a prospective view of a third embodiment of the structure of the container according to the invention, set up in a rectangular manner;

The FIG. 4 represents a prospective view of a fourth embodiment of the structure of the container according to the invention, again set up in a rectangular manner;

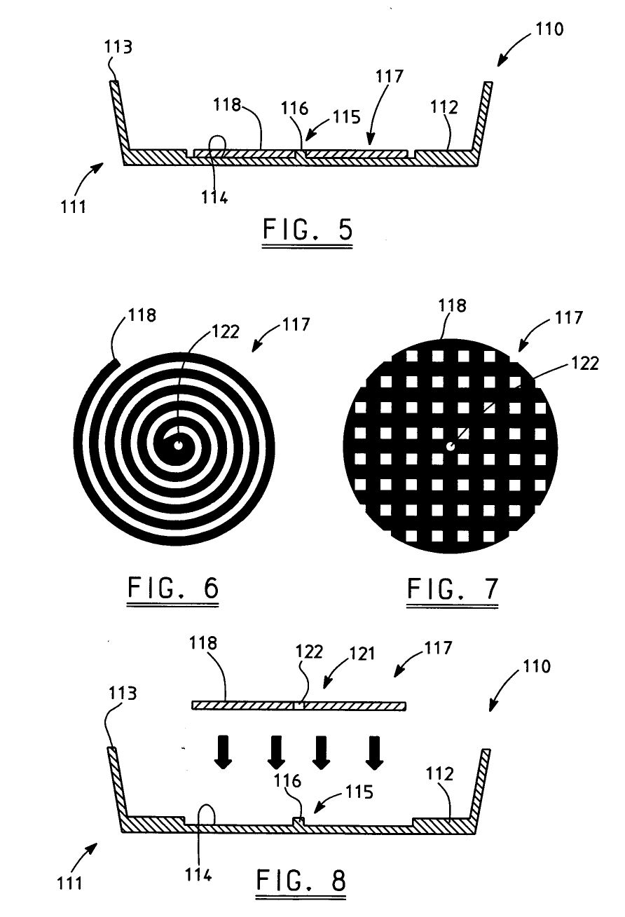

The FIG. 5 represents a sectional view according to a vertical plane of a fifth structure of the container according to the invention;

The FIGS. 6 and 7 represent ground views, seen from the top, of a first and a second embodiment of the inhibiting device according to the invention;

The FIG. 8 represents a sectional view according to a vertical plane of said fifth structure of a container, according to the invention, in a condition approaching assembly.

With reference to the figures in the attached drawings, the structure of the inhibiting container to inhibit the proliferation of insects in a liquid body is indicated as a whole by the reference number 10 in the embodiments of the

FIGS. 1, 2, 3 and 4, and by the reference number 110 in the FIG. 5.

Said structure 10, 110 comprises above all a containment body, indicated as a whole by the reference number 11, 111 to contain said liquid body. In detail, said containment body 11, 111 comprises a floor 12, 112 and a peripheral/circumferential rim 13, 113. According to the embodiment shown in particular in FIG. 5, said floor 112 comprises a seating indent 114 and coupling means indicated as a whole by the reference number 115. Said seating indent 114 is appropriately provided in the central area of said floor 112. Said coupling means 115 are in turn arranged at the center of said seating indent 114. Said coupling means 115 appropriately comprise an engaging pin 116.

Said structure 10, 110 also comprises inhibiting devices, indicated as a whole by the reference numbers 17, 117, that are in contact with said liquid body to inhibit said proliferation of insects. Said inhibiting devices 17, 117 are appropriately at least partially incorporated in said containment body 11, 111. In this way, said structure of the container 10, 110 is capable of simultaneously performing both functions of containing said liquid body and of being insecticidal to said insects. These inhibiting devices 17 and 117 are uniformly arranged on said containment body 11, 111, According to the embodiments shown in the Figures from 1 to 4, said inhibiting devices 17 comprise bacteriostatic elements of a rod-type 18, a circular type 19 and a disc type 20. The latter advantageously set up a plurality of geometric configurations. According to the embodiment shown in the Figures from 5 to 7, said inhibiting devices 117 comprise bacteriostatic elements 118 and coupling means 121 to couple said bacteriostatic elements 118 to said containment body 111. Said bacteriostatic elements 118 are appropriately of a platelet type. Said bacteriostatic elements 118 may also be set up as spirals, as shown in FIG. 6, or in a reticulated manner as shown in FIG. 7. Said coupling means 121 are in turn provided at the center of said bacteriostatic elements 118. In detail, said coupling means 121 comprise an engaging hole 122. The mentioned inhibiting devices 17, 117 are appropriately containing bacteriostatic metals. The quantities of bacteriostatic metals employed depend on the containment capacity of said containment body 11, 111. The bacteriostatic elements used are preferably copper and/or silver. This structure, particularly in the embodiments illustrated in the Figures from 1 to 5, is also advantageously suited for realizing saucers of (not illustrated) pots for flower and/or fruit plants.

With reference to FIG. 8, the method of assembling an inhibiting device 117 such as illustrated in the FIGS. 6 and 7 to a containment body 111 occurs as follows. In short, there is a first approaching operation to approach said inhibiting device 117 to the floor 112 of said containment body 111, and a second incorporating operation to incorporate said inhibiting device 117 in said containment body 111, so as to set up the structure of the inhibiting container 110 shown in FIG. 5.

It has in practice been verified that the structure of the inhibiting container, the inhibiting device and the method of assembly achieve their aim and their pre-established objects, while overcoming the drawbacks found in the prior art. In particular, it was verified that the container structure and the device are able of ensuring high practical standards of usage, so as to motivate the users to use them. Moreover, it was verified that that the structure of the inhibiting container and the inhibiting device are able of ensuring safe usage standards of an absolute value, in particular with respect to children and household pets. It was further ascertained that the structure of the container and the device are able of facilitating disposal operations for both users and companies. It was also verified that the structure of the container and the device are always capable of ensuring a positive bacteriostatic treating result. It was also appreciated that the structure of the container is aesthetically enhanced. In conclusion, it was verified that the structure of the container and the device are economical, produced in a simple manner, fully and easily recycled and that the method of assembly allows a simple and immediate implementation.

In a practical embodiment, the materials employed, the dimensions and the executive details may differ from those indicated here but be technically equivalent to them, without thereby abandoning the scope of the invention.

1. A structure of an inhibiting container to inhibit the proliferation of insects in a liquid body, comprising a containment body to contain said liquid body and inhibiting devices in contact with said liquid body to inhibit said proliferation of said insects wherein said inhibiting devices are at least partially incorporated in said containment body so that said structure of a container simultaneously performs both functions of containing said liquid and of being insecticidal to said insects.

2. The structure according to claim 1 wherein said containment body comprises a floor and a peripheral/circumferential rim.

3. The structure according to claim 1 wherein said floor comprises a seating indent and coupling means.

4. The structure, according to claim 3 wherein said seating indent is provided in the central area of said floor.

5. The structure, according to claim 3 wherein said coupling means are arranged at the center of said seating indent.

6. The structure, according to claim 3 wherein said coupling means comprise an engaging pin.

7. The structure, according to claim 1 wherein said inhibiting devices are uniformly arranged on said containment body.

8. The structure according to claim 1 wherein said inhibiting devices comprise rod-shaped, circular and disc-shaped bacteriostatic elements.

9. The structure according to claim 8 wherein said bacteriostatic elements realize a plurality of geometric configurations.

10. The structure according to claim 1 wherein said inhibiting devices comprise bacteriostatic elements and coupling means to couple said bacteriostatic elements to said containment body.

11. The structure according to claim 10 wherein said bacteriostatic elements are of a platelet form.

12. The structure according to claim 10 wherein said bacteriostatic elements are of a spiral or reticulated form.

13. The structure according to claim 10 wherein said coupling means are provided at the center of said bacteriostatic elements.

14. The structure according to claim 10 wherein said coupling means comprise an engaging hole.

15. The structure according to claim 1 wherein said inhibiting means contain bacteriostatic metals.

16. The structure according to claim 15 wherein the quantity of bacteriostatic metals used depend on the containing capacity of said containment body.

17. The structure according to claim 15 wherein said bacteriostatic metals are copper and/or silver.

18. The structure according to claim 1 wherein it is able of being employed to produce saucers for pots of flower and/or fruit plants.

19. An inhibiting device to inhibit the proliferation of insects in a liquid body capable of being incorporated in a containment body comprising bacteriostatic elements to be placed in contact with said liquid body to impede said proliferation of said insects the device comprising coupling means to couple said bacteriostatic elements to said containment body so as to realize a structure of an inhibiting container able of simultaneously performing both functions of containing said liquid body and of being insecticidal to said insects.

20. A method of assembling an inhibiting device to inhibit the proliferation of insects in a liquid body to a containment body characterized in that it comprises an approaching operation to approach said inhibiting device to the floor of said containment body, and an incorporating operation to incorporate said inhibiting device in said containment body, so as to realize a structure of an inhibiting container able of simultaneously performing both functions of containing said liquid body and of being insecticidal to said insects.
